(19) United States
(12) Patent Application Publication
(10) Pub. No.: US 2023/0420702 A1
(43) Pub. Date: Dec. 28, 2023

(54) Leaf vein flow channel bionic air-cooled fuel cell module supporting lung air intake and implementation method thereof

(71) Applicant: Jilin University, Changchun (CN)

(72) Inventors: Guolong Lu, Changchun (CN); Mi Wang, Changchun (CN); Ruoyu Cui, Changchun (CN); Yina Dai, Changchun (CN); Shishen Jiang, Changchun (CN); Zhenning Liu, Changchun (CN)

(21) Appl. No.: 18/213,891

(22) Filed: Jun. 26, 2023

(30) Foreign Application Priority Data
Jun. 27, 2022 (CN) 202210733365.X

(51) Int. Cl. H01M 8/0265; H01M 8/04014; H01M 8/04089

(52) U.S. Cl. CPC H01M 8/0265; H01M 8/04014; H01M 8/04089

(57) ABSTRACT

Disclosed are a leaf vein flow channel bionic air-cooled fuel cell module supporting lung air intake, and a method thereof. A circular columnar stack is arranged in a cylindrical impeller and is placed in a cylindrical sealing volute, such that the circular columnar stack is suitable for the cylindrical body structure of drones and unmanned submersibles. A cathode surface and an anode surface are integrated on a same bipolar plate. The cathode surface adopts a mesh vein distribution pattern imitating veins of a lotus leaf, and the anode surface adopts a distribution pattern imitating veins of a banana leaf. In this way, even diffusion of gas is facilitated, and gas reaction is even. In addition, parasitic power consumed by a motor driving an impeller is small.

### CROSS-REFERENCE TO RELATED APPLICATIONS

This application claims priority of Chinese Patent Application No. 202210733365.X, filed on Jun. 27, 2022, the entire contents of which are incorporated herein by reference.

### TECHNICAL FIELD

The present disclosure relates to the technical field of fuel cells, and in particular, relates to a leaf vein flow channel bionic air-cooled fuel cell module supporting lung air intake, and an implementation method thereof.

### BACKGROUND

A fuel cell module is an electrochemical device that converts chemical energy into electrical energy. The essence of power generation is that the chemical potential generated by the chemical reaction drives the electric current to do work, and the chemical energy in hydrogen and oxygen is converted into electrical energy by a catalyst and a proton membrane inside each cell in a stack, while generating water and heat. With the advantages of high energy density, high energy conversion efficiency, zero emission, and no mechanical noise, the fuel cell module is widely used in military and civil fields. A proton exchange membrane-based fuel cell module uses hydrogen as fuel, and a plurality of cells are connected in series or parallel to form stacks of different power.

Proton exchange membrane-based fuel cell modules are categorized into liquid-cooled and air-cooled fuel cell modules according to the form of heat dissipation. Low-power fuel cell modules below 10 kW are generally air-cooled, while those above 10 kW are generally liquid-cooled. Air-cooled fuel cell modules are the earliest type of fuel cell modules developed. The current air-cooled fuel cell modules have an open structure and use fans to supply air to the cell modules while discharging the heat inside the fuel cell modules, and the entire cooling system and the air supply system are integrated together without auxiliary components such as air compressors and cooling water pumps, and the cathode is an open gas exchange structure. Therefore, the overall structure is relatively simple, which not only reduces costs of the fuel cell module system but also effectively reduces parasitic energy consumption of the fuel cell module. The parasitic energy consumption of this open air-cooled fuel cell module is about 5 to 10% of the output power of the fuel cell module system.

At present, for ease of stacking and placement, the stacks are square, suitable for cars, ships and other mobile platforms with large space. As for special operating conditions, structural bodies of such as drones, submersibles, and special robots are columnar. As for the platform equipment with high requirements for range and instantaneous high power output, no suitable stack is available in the market. Stacks mostly adopt open air intake, and relying on heat, free or forced air convection, intake air from one end, cool the polar plates. As a result, cathode gas diffusion is not even, poor gas exchange is poor, power is low, which seriously affect the performance and application scenarios of the fuel cell module.

### SUMMARY

In order to overcome the above deficiencies in the related art, various embodiments of the present disclosure provide a leaf vein flow channel bionic air-cooled fuel cell module supporting lung air intake, and an implementation method thereof, such that the problems of uneven gas diffusion, poor gas exchange, poor drainage performance, and low power and power density are addressed.

In one aspect of the embodiments of the present disclosure, a leaf vein flow channel bionic air-cooled fuel cell module supporting lung air intake is provided.

The leaf vein flow channel bionic air-cooled fuel cell module supporting lung air intake of the present disclosure includes: an air inlet, a front fixing plate, a stack, a motor, a sealing volute, an impeller, a rear fixing plate, and an air outlet; wherein the sealing volute is a cylindrical structure having no upper bottom but having a lower bottom; the air outlet is arranged in a side wall of the sealing volute along a direction parallel to an axis of the sealing volute; the impeller is coaxially arranged inside the sealing volute, and the impeller is a cylindrical structure having no upper bottom but having a lower bottom; the rear fixing plate is coaxially arranged at a bottom inside the impeller, and the rear fixing plate is a circular flat structure; the motor is arranged at a center of the rear fixing plate; a transmission shaft of the motor is fixedly connected to a center of a bottom surface of the impeller; the stack in a circular columnar structure is coaxially mounted inside the impeller; the front fixing plate is coaxially connected at a top portion of the impeller, and a plurality of long screws are axially evenly distributed around the stack, front ends of the long screws are fixedly connected to the front fixing plate, and rear ends of the long screws are fixedly connected to the rear fixing plate, such that the stack is fixedly mounted between the front fixing plate and the rear fixing plate; a front end of the sealing volute is fixedly mounted at an edge of the front fixing plate; a through hole is arranged at a center of the front fixing plate, and the air inlet is arranged in the through hole; wherein
an area of a cross section, along an air flow direction, of the air inlet progressively decreases along the air flow direction, such that an area at a front end of the air inlet is larger, and an area at a rear end of the air inlet is smaller;
the stack includes a plurality of cells successively coaxially stacked, wherein each of the cells includes from front to rear a bipolar plate, an anode diffusion layer, a proton membrane, and a cathode diffusion layer successively, and each of the cells is in a circular shape, such that the stack formed by stacking the plurality of cells is in a circular shape and a columnar space is defined inside the stack; wherein the bipolar plate employs an circular plate-shaped substrate, and a front surface, facing towards the cathode diffusion layer of a previous cell, of the bipolar plate is a cathode surface, and a rear surface, facing towards the anode diffusion layer, of the bipolar plate is an anode surface; wherein
the cathode surface adopts a mesh vein distribution pattern imitating veins of a lotus leaf; on the front surface of the circular plate-shaped substrate, arrays of cylinders are arranged like mesh veins to form mesh flow channels; a circular inner diffusion flow channel and a circular outer diffusion flow channel are respectively arranged in an inner edge and an outer edge of the front surface of the circular plate-shaped substrate; the mesh flow channels between the inner diffusion flow channel and the outer diffusion flow channel are divided by first-stage to Mth-stage flow channels, and the mesh flow channels and the first-stage to Mth-stage flow channels together form a cathode flow channel network; a plurality of first-stage flow channels distributed radially and centrosymmetrically are inscribed in an outer edge of the inner diffusion flow channel, and the first-stage flow channels are communicated with the inner diffusion flow channel; two communicated ith-stage flow channels are inscribed in a tail end of each of (i−1)th-stage flow channels, and the two ith-stage flow channels each have an included angle with a corresponding (i−1)th-stage flow channel and are symmetrically distributed about the (i−1)th-stage flow channel; a tail end of the Mth-stage flow channel is communicated with an inner edge of the outer diffusion flow channel, wherein 2≤i≤M, M is a natural number ≥2; and a width of the (i−1)th-stage flow channel is less than a width of the ith-stage flow channel;
the anode surface adopts a distribution pattern imitating veins of a banana leaf; a circular inner non-flow channel region and a circular outer non-flow channel region are respectively arranged in an inner edge and an outer edge of the rear surface of the circular plate-shaped substrate to form contact regions; a circular inner air collector flow channel and a circular outer air collector flow channel are respectively inscribed in an outer edge of the inner non-flow channel region and an inner edge of the outer non-flow channel region; N air inlet openings and N air outlet openings running through the anode surface and the cathode surface of the bipolar plate are respectively arranged in the anode surface, the air inlets and the air outlets are staggered, a primary air collector flow channel is arranged along a radial direction of the air outlet openings, and the primary air collector flow channel divides, along the radial direction of the air inlet openings, a region between the inner air collector flow channel and the outer air collector flow channel into 2N anode sub-regions symmetrical about a center thereof, N being a natural number greater than or equal to 1; in each of the anode sub-regions, a primary flow channel communicating the air inlet with the air outlet is inscribed between the air inlet opening and the air outlet opening, a central line of the primary flow channel is a circular arc, and a width of the primary flow channel progressively decreases from the air inlet to the air outlet; an inner branch flow channel and an outer branch flow channel are respectively arranged between the primary flow channel and the inner air collector flow channel and between the primary flow channel and the outer air collector flow channel, a width of the inner branch flow channel progressively decreases from the primary channel to the inner air collector flow channel and a width of the outer branch flow channel progressively decreases from the primary channel to the outer air collector flow channel, central lines of the inner air collector flow channels are parallel to each other, center lines of the outer air collector flow channels are parallel to each other, and an included angle is defined between the inner branch flow channel and the outer branch flow channel; the width of the primary flow channel is greater than the width of the inner branch flow channel and the width of the outer branch flow channel; on the front fixing plate, a hydrogen inlet is arranged at a position corresponding to the air inlet opening in the bipolar plate, and the hydrogen inlet is communicated with the air inlet opening in the bipolar plate; and on the front fixing plate, a hydrogen outlet is arranged at a position corresponding to the air outlet opening in the bipolar plate, and the hydrogen outlet is communicated with the air outlet opening in the bipolar plate;
air enters from the air inlet to the cathode surface inside the sealing volute of the fuel cell module while hydrogen enters the anode surface inside the sealing volute of the fuel cell module through the hydrogen inlet, and the motor drives the impeller to rotate; the air enters the fuel cell module in a way that imitates an air intake pattern of a lung, wherein the air is compressed at the air inlet to obtain a greater flow rate for flowing through the fuel cell module; the motor drives the impeller to rotate, and the impeller provides additional power to the air, such that volume expansion of the air is accelerated and the air quickly passes through the stack;
upon entry into the sealing volute, the air enters the columnar space inside the circular columnar stack and reaches the cathode surface of each of the cells in the stack, and is transported to the primary flow channel through the inner diffusion flow channel; a small amount of the air enters the mesh flow channel in a region near the primary flow channel, and is diffused within the mesh flow channel; most of the air is transported through the primary flow channel and enters narrower secondary flow channels successively up to the Mth-stage flow channel, and is diffused to the outer diffusion flow channel in the edge of the cathode flow channel network; an air flow rate is greater while being diffused to accommodate an increase in an area of the bipolar plate corresponding to the cell as an radial transportation unit length increases; and the air is evenly diffused in the cathode flow channel network while being diffused to the cathode diffusion layer of the previous cell, the region where the air is diffused to the cathode diffusion layer constitutes a reaction region, oxygen in the air participates in reaction to generate cathode water, and the gas not participating in the reaction in the air takes away the generated cathode water and heat and is finally discharged from the air outlet;
when an amount of the generated cathode water is small, the cathode water gathers at a bottom of the cathode flow channel network and forms a liquid water membrane at the bottom, the water membrane forms a liquid-gas mixed phase with the air, and the air evenly forms a flow field in the cathode flow channel network, which is conducive to the reaction while ensuring a smaller parasitic resistance;
when the amount of the generated cathode water is over large, widths of the first-stage to Mth-stage flow channels of the cathode flow channel network decrease stage by stage, an additional pressure exerts a capillary effect which automatically cooperates with the air flow to discharge the gas not participating in the reaction along a radial direction, and further under power of the impeller, the cathode water is further radially transported with a transportation direction of the gas and is finally discharged from the air outlet in the side wall of the sealing volute to prevent the stack from being flooded; in terms of heat dissipation, heat is evenly generated in the whole reaction region, the heat transferred to the cathode surface is gathered on a surface of the array of cylinders, and since the arrays of cylinders are evenly arranged, the heat is evenly gathered on the surface such that a heat dissipation area is increased; further, the heat transferred to the cathode surface is transferred to gas not participating in the reaction in the air, the gas not involved in the reaction in the air include gas not intended to participate in the reaction and the oxygen in the air failing to participate in the reaction timely, the oxygen in the air participates in the reaction during transportation and is gradually consumed, and the width of the flow channel decreases during transportation of the gas not participating in the reaction in the air along the first-stage to Mth-stage flow channels, but more heat is accumulated, the heat causes the gas not participating in the reaction in the air to expand, such that the pressure of the gas not participating in the reaction in the air increases in the limited space and is discharged from the air outlet more quickly, making the air pressure inside the sealing volute smaller and causing a pressure difference with the outside of the sealing volute, accelerating the entry of the air from the air inlet, and thus the heat provides the additional pressure for the air entering through the air inlet, which increases the air flow rate, improves an air exchange efficiency, and facilitates quickly taking away the heat by the air; and
the hydrogen enters the anode surface through the air inlet opening and is transferred to the inner branch flow channel and the outer branch flow channel through the primary flow channel; since the width of the primary flow channel progressively decreases, the inner branch flow channel and the outer branch flow channel become narrower gradually, and according to the Bernoulli's law, the hydrogen is diffused quickly and evenly to each of anode sub-regions of the anode surface; most of the hydrogen is diffused to the anode diffusion layer to participate in the reaction, and a small portion of unreacted hydrogen is gathered in the inner air collector flow channel and the outer air collector flow channel and is transferred to an anode surface of a next cell through the air outlet opening; when a temperature sensor set between the stacks detects that a temperature of the cell is too high, a impeller speed is controlled to speed up to accelerate the air flow rate in the cathode flow channel network, and the entry of the hydrogen is controlled to be reduced at the same time; since an amount of entered hydrogen is reduced, and a hydrogen consumption rate in the primary flow channel and the inner and outer branch flow channels is accelerated with the air flow in the cathode flow channel network, such that the hydrogen in the main stream channel and the inner and outer branch channels is consumed quickly, and lack of the hydrogen available for the reaction slows down the reaction and slows down generation of the cathode water, but the impeller speed is accelerated, which makes the air flow rate in the cathode flow channel network accelerated to quickly take away the heat and the cathode water remaining on the cathode surface.

In some embodiments, the impeller includes: a fixing plate, fan blades, and a fixing ring; wherein the fixing plate is a flat plate perpendicular to an axis of the sealing volute; bottoms of a plurality of evenly distributed fan blades are mounted on an edge of an inner surface of the fixing plate, and each of the fan blades is a flat plate parallel to the axis of the sealing volute; tops of the plurality of fan blades are fixed by the fixing ring; the fixing ring is mounted on the rear surface of the front fixing plate by a bearing, such that the fixing ring is rotatable with the impeller, and the front fixing plate is fixed on the sealing volute and remains stationary; and a shaft slot is arranged at a center of the fixing plate, and a drive shaft of the motor is fixedly mounted in the shaft slot of the fixing plate.

In some embodiments, the front fixing plate, the rear fixing plate, and the sealing volute are made of one of thermoplastic polyimide, polyetheretherketone, polytetrafluoroethylene, and silicone rubber, which are injected into the fixed mold and have good physical and mechanical properties, insulation properties and heat resistance to ensure that the performance of the battery shell is not affected by the battery heat production and voltage during the reaction.

In some embodiments, adjacent cells in the stack are bonded by the contact regions; the outer edge of the stack is tightly sealed by a number of screws evenly distributed along the outer edge.

In some embodiments, the substrate of the bipolar plate is made of one of graphite, metal, and a composite material.

In some embodiments, cylinders of the arrays of cylinder on cathode surface have a diameter of 2 to 4 mm, a spacing of 3 to 5 mm, and a height of 2 to 3 mm.

In some embodiments, the first-stage flow channels in the cathode surface have a width of 2 to 5 mm, adjacent first-stage flow channels have an included angle of 360°/P, a number P of first-stage flow channels satisfies 15≤P≤25, the widths of the first-stage to Mth-stage flow channels of the cathode surface decrease stage by stage, and a cube of the width of the (i−1)th-stage flow channel is equal to twice a cube of a width of the ith-stage flow channel. The included angle between the two ith-stage flow channels is 2050 degree. The width of the inner diffusion flow channel and the outer diffusion flow channel is 3-7 mm.

In some embodiments, the width, in the air inlet opening, of the primary flow channel on the anode surface ranges from 6 to 10 mm, and the width, in the air outlet opening, of the primary flow channel ranges from 1 to 4 mm; diameters of the air inlet opening and the air outlet opening range from 3 to 7 mm; the widths of the inner branch flow channel and the outer branch flow channel range from 1 to 4 mm; and widths of the inner air collector flow channel and the outer air collector flow channel range 2 to 5 mm, a width of the primary air collector flow channel range from 4 to 10 mm, and widths of the inner non-flow channel region and the outer non-flow channel region range from 2 to 10 mm.

In another aspect of the embodiments of the present disclosure, an implementation method of the leaf vein flow channel bionic air-cooled fuel cell module supporting lung air intake is provided.

The implementation method of the leaf vein flow channel bionic air-cooled fuel cell module supporting lung air intake includes the following steps:
(1) air enters from the air inlet to the cathode surface inside the sealing volute of the fuel cell module while hydrogen enters the anode surface inside the sealing volute of the fuel cell module through the hydrogen inlet, and the motor drives the impeller to rotate; the air enters the fuel cell module in a way that imitates an air intake pattern of a lung, wherein the air is compressed at the air inlet to obtain a greater flow rate for flowing through the fuel cell module; the motor drives the impeller to rotate, and the impeller provides additional power to the air, such that volume expansion of the air is accelerated and the air quickly passes through the stack;
(2) upon entry into the sealing volute, the air enters the columnar space inside the circular columnar stack and reaches the cathode surface of each of the cells in the stack, and is transported to the primary flow channel through the inner diffusion flow channel; a small amount of the air enters the mesh flow channel in a region near the primary flow channel, and is diffused within the mesh flow channel; most of the air is transported through the primary flow channel and enters narrower secondary flow channels successively up to the Mth-stage flow channel, and is diffused to the outer diffusion flow channel in the edge of the cathode flow channel network; an air flow rate is greater while being diffused to accommodate an increase in an area of the bipolar plate corresponding to the cell as an radial transportation unit length increases; and the air is evenly diffused in the cathode flow channel network while being diffused to the cathode diffusion layer of the previous cell, the region where the air is diffused to the cathode diffusion layer constitutes a reaction region, the oxygen in the air participates in reaction to generate cathode water, and the gas not participating in the reaction in the air takes away the generated cathode water and heat and is finally discharged from the air outlet;
(3) when an amount of the generated cathode water is small, the cathode water gathers at a bottom of the cathode flow channel network and forms a liquid water membrane at the bottom, the water membrane forms a liquid-gas mixed phase with the air, and the air evenly forms a flow field in the cathode flow channel network, which is conducive to the reaction while ensuring a smaller parasitic resistance;
(4) when the amount of the generated cathode water is over large, widths of the first-stage to Mth-stage flow channels of the cathode flow channel network decrease stage by stage, an additional pressure exerts a capillary effect which automatically cooperates with the air flow to discharge the gas not participating in the reaction along a radial direction, and further under power of the impeller, the cathode water is further radially transported with a transportation direction of the gas and is finally discharged from the air outlet in the side wall of the sealing volute to prevent the stack from being flooded; in terms of heat dissipation, heat is evenly generated in the whole reaction region, the heat transferred to the cathode surface is gathered on a surface of the array of cylinders, and since the arrays of cylinders are evenly arranged, the heat is evenly gathered on the surface such that a heat dissipation area is increased; further, the heat transferred to the cathode surface is transferred to gas not participating in the reaction in the air, the gas not involved in the reaction in the air includes gas not intended to participate in the reaction and the oxygen in the air failing to participate in the reaction timely, the oxygen in the air participates in the reaction during transportation and is gradually consumed, and the width of the flow channel decreases during transportation of the gas not participating in the reaction in the air along the first-stage to Mth-stage flow channels, but more heat is accumulated, the heat causes the gas not participating in the reaction in the air to expand, such that the pressure of the gas not participating in the reaction in the air increases in the limited space and is discharged from the air outlet more quickly, making the air pressure inside the sealing volute smaller and causing a pressure difference with the outside of the sealing volute, accelerating the entry of the air from the air inlet, and thus the heat provides the additional pressure for the air entering through the air inlet, which increases the air flow rate, improves an air exchange efficiency, and facilitates quickly taking away the heat by the air; and
(5) the hydrogen enters the anode surface through the air inlet opening and is transferred to the inner branch flow channel and the outer branch flow channel through the primary flow channel; since the width of the primary flow channel progressively decreases, the inner branch flow channel and the outer branch flow channel become narrower gradually, and according to the Bernoulli's law, the hydrogen is diffused quickly and evenly to each of anode sub-regions of the anode surface; most of the hydrogen is diffused to the anode diffusion layer to participate in the reaction, and a small portion of unreacted hydrogen is gathered in the inner air collector flow channel and the outer air collector flow channel and is transferred to an anode surface of a next cell through the air outlet opening; when a temperature sensor set between the stacks detects that a temperature of the cell is too high, a impeller speed is controlled to speed up to accelerate the air flow rate in the cathode flow channel network, and the entry of the hydrogen is controlled to be reduced at the same time; since an amount of entered hydrogen is reduced, and a hydrogen consumption rate in the primary flow channel and the inner and outer branch flow channels is accelerated with the air flow in the cathode flow channel network, such that the hydrogen in the main stream channel and the inner and outer branch channels is consumed quickly, and lack of the hydrogen available for the reaction slows down the reaction and slows down generation of the cathode water, but the impeller speed is accelerated, which makes the air flow rate in the cathode flow channel network accelerated to quickly take away the heat and the cathode water remaining on the cathode surface.

The present disclosure has the following advantages:
(1) The present disclosure generally adopts a cylindrical closed structure, which is suitable for the columnar body structure of drones and unmanned submersibles. According to the technical solutions of the present disclosure, the impeller supporting active air intake is placed around the outer side of the stack and does not additionally occupy the space of the overall structure, thereby making full use of space and increasing the power per unit volume.
(2) The cathode surface and the anode surface are integrated on the same bipolar plate, which is convenient for manufacturing and replacement.
(3) The cathode surface adopts the lotus leaf bionic design and the anode surface adopts the banana leaf bionic design, which not only facilitates the even diffusion of gas and makes the gas react evenly, but also makes the parasitic power consumed by the motor driving the impeller smaller.
(4) The cathode surface adopts the bionic vapor chamber design, such that the heat is distributed evenly without gathering, and not only the cathode flow channel network on the cathode surface of the bipolar plate of the cell module forms a pathway for air heat conduction, the arrays of cylinders also form independent heat dissipation units, thereby increasing the contact region for heat transfer. This is conducive to providing an additional pressure for the gas to increase the flow rate and enhancing the heat dissipation capacity.
(5) The cathode plate takes advantages of the capillary effect, which facilitates rapid discharge of cathode water under conditions of more cathode water and prevents the cell module from being flooded;
(6) The present disclosure is suitable for promotion in equipment that meets the operating conditions.

### BRIEF DESCRIPTION OF THE DRAWINGS

FIG. 1 is a schematic view of the exterior of a leaf vein flow channel bionic air-cooled fuel cell module supporting lung air intake according to an exemplary embodiment of the present disclosure;

FIG. 2 is an exploded view of the leaf vein flow channel bionic air-cooled fuel cell module supporting lung air intake according to an exemplary embodiment of the present disclosure;

FIG. 3 is an exploded view of a cell of the leaf vein flow channel bionic air-cooled fuel cell module supporting lung air intake according to an exemplary embodiment of the present disclosure;

FIG. 4 is a front view of a cathode surface of the leaf vein flow channel bionic air-cooled fuel cell module supporting lung air intake according to an exemplary embodiment of the present disclosure;

FIG. 5 is an enlarged view of the cathode surface of the leaf vein flow channel bionic air-cooled fuel cell module supporting lung air intake according to an exemplary embodiment of the present disclosure;

FIG. 6 is a front view of an anode surface of the leaf vein flow channel bionic air-cooled fuel cell module supporting lung air intake according to an exemplary embodiment of the present disclosure; and

FIG. 7 is a sectional view of the leaf vein flow channel bionic air-cooled fuel cell module supporting lung air intake according to an exemplary embodiment of the present disclosure.

### DETAILED DESCRIPTION

Hereinafter the present disclosure is further described with reference to some specific embodiments and in conjunction with accompanying drawings.

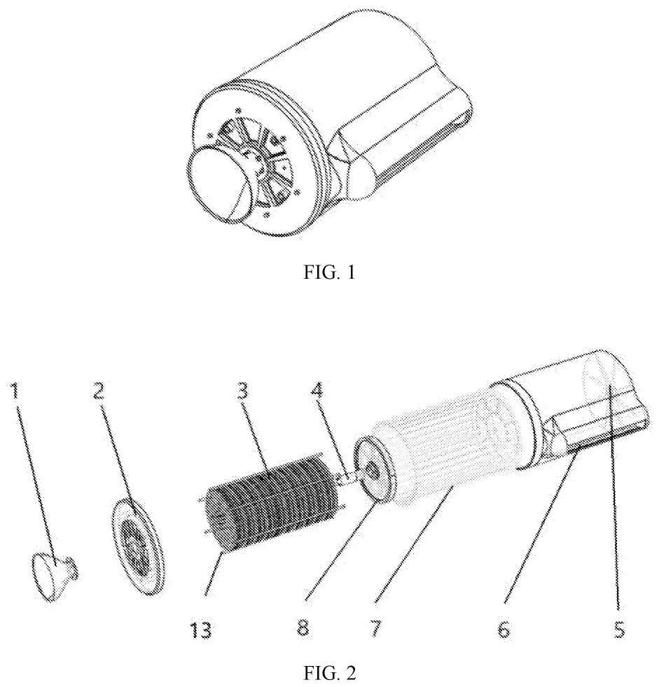

As illustrated in FIG. 1 and FIG. 2, a leaf vein flow channel bionic air-cooled fuel cell module supporting lung air intake according to an embodiment of the present disclosure includes: an air inlet 1, a front fixing plate 2, a stack 3, a motor 4, a sealing volute 5, an impeller 7, a rear fixing plate 8, and an air outlet 6; wherein the sealing volute 5 is a cylindrical structure having no upper bottom but having a lower bottom; the air outlet 6 is arranged in a side wall of the sealing volute 5 along a direction parallel to an axis of the sealing volute 5; the impeller 7 is coaxially arranged inside the sealing volute 5, and the impeller 7 is a cylindrical structure having no upper bottom but having a lower bottom; the rear fixing plate 8 is coaxially arranged at a bottom inside the impeller 7, and the rear fixing plate 8 is a circular flat structure; the motor 4 is arranged at a center of the rear fixing plate 8; a transmission shaft of the motor 4 is fixedly connected to a center of a bottom surface of the impeller 7; the stack 3 in a circular columnar structure is coaxially mounted inside the impeller 7; the front fixing plate 2 is coaxially connected at a top portion of the impeller 7, and a plurality of long screws 13 are axially evenly distributed around the stack 3, front ends of the long screws 13 are fixedly connected to the front fixing plate 2, and rear ends of the long screws 13 are fixedly connected to the rear fixing plate 8, such that the stack 3 is fixedly mounted between the front fixing plate 2 and the rear fixing plate 8; a front end of the sealing volute 5 is fixedly mounted at an edge of the front fixing plate 2; a through hole is arranged at a center of the front fixing plate 2, and the air inlet 1 is arranged in the through hole.

An area of a cross section, along an air flow direction, of the air inlet 1 progressively decreases along the air flow direction, such that an area at a front end of the air inlet is larger, and an area at a rear end of the air inlet is smaller, that is, a horn shape or a funnel shape.

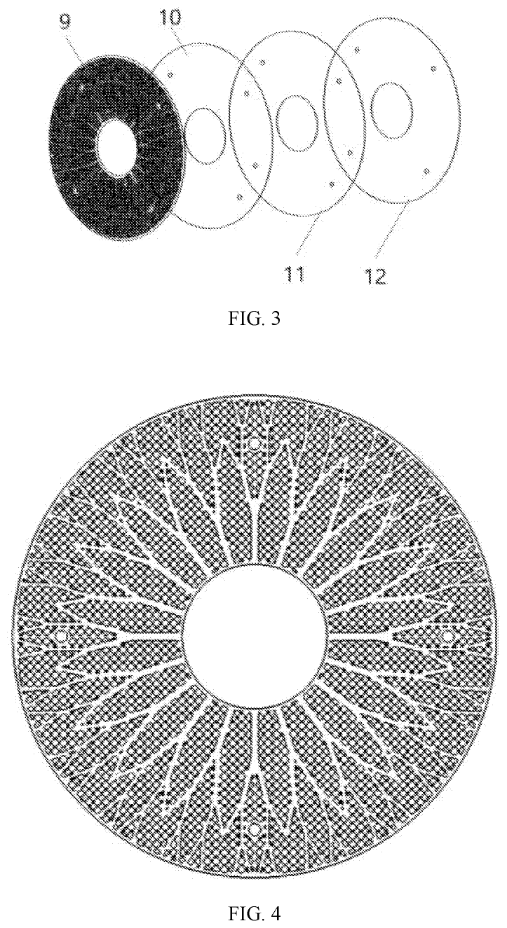

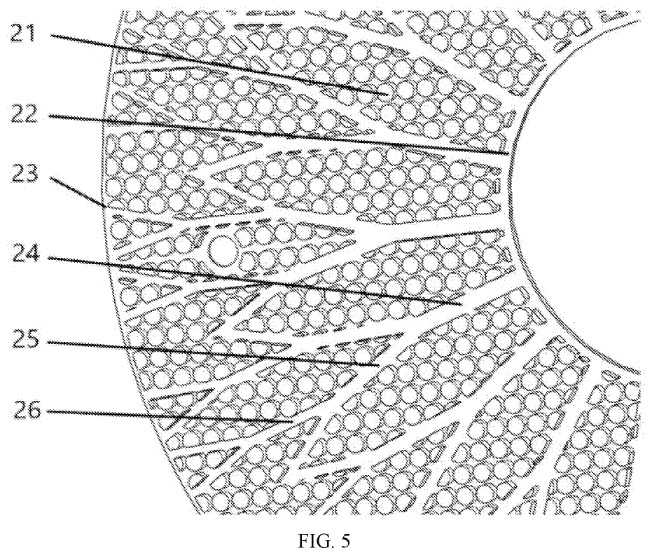

As illustrated in FIG. 3, the stack includes a plurality of cells successively coaxially stacked, wherein each of the cells includes from front to rear a bipolar plate 9, an anode diffusion layer 10, a proton membrane 11, and a cathode diffusion layer 12 successively, and each of the cells is in a circular shape, such that the stack formed by stacking the plurality of cells is in a circular shape and a columnar space is defined inside the stack; wherein the bipolar plate employs an circular plate-shaped substrate, and a front surface, facing towards the cathode diffusion layer of a previous cell, of the bipolar plate is a cathode surface, and a rear surface, facing towards the anode diffusion layer, of the bipolar plate is an anode surface.

As illustrated in FIG. 4, the cathode surface adopts a mesh vein distribution pattern imitating veins of a lotus leaf; on the front surface of the circular plate-shaped substrate, arrays of cylinders 21 are arranged like mesh veins to form mesh flow channels; an inner diffusion flow channel 22 and an outer diffusion flow channel 23 are respectively arranged in an inner edge and an outer edge of the front surface of the circular plate-shaped substrate; the mesh flow channels between the inner diffusion flow channel and the outer diffusion flow channel are divided by a first-stage flow channel 24, a second-stage flow channel 25, and a third-stage flow channel 26, and the mesh flow channels and the first-stage to third-stage flow channels together form a cathode flow channel network; a plurality of first-stage flow channels, 20 first-stage flow channels, distributed radially and centrosymmetrically are inscribed in an outer edge of the inner diffusion flow channel, and the first-stage flow channels are communicated with the inner diffusion flow channel; two communicated second-stage flow channels are inscribed in a tail end of each of the first-stage flow channels, and the two second-stage flow channels each have an included angle with the corresponding first-stage flow channel and are symmetrically distributed about the first-stage flow channel; two communicated third-stage flow channels are inscribed in a tail end of each of the second-stage flow channels; the two third-stage flow channels each have an included angle with the corresponding second-stage flow channel and are symmetrically distributed about the second-stage flow channel; a tail end of the third-stage flow channel is communicated with an inner edge of the outer diffusion flow channel; and an included angle between two second-stage flow channels is 30 degrees and an included angle between two third-stage flow channels is 30 degrees.

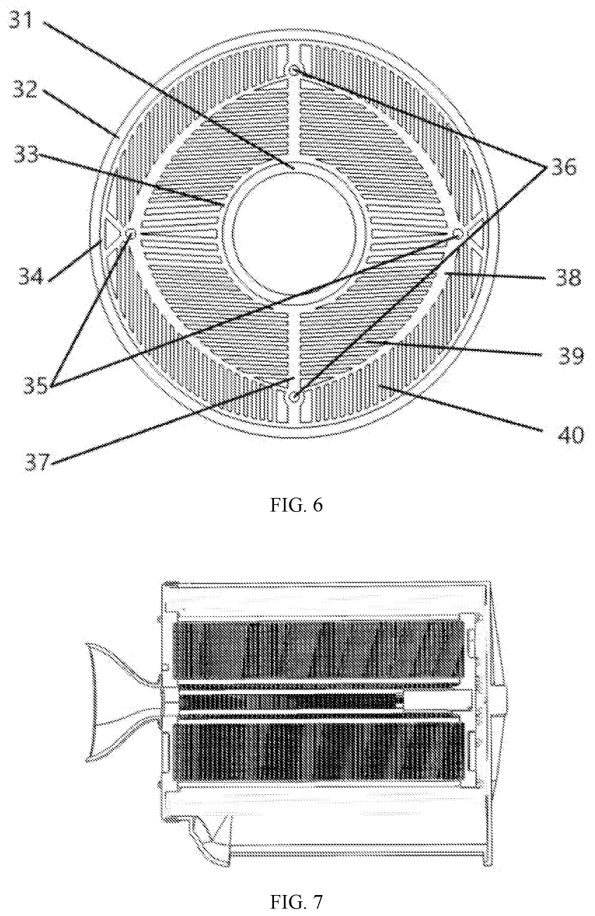

As illustrated in FIG. 6, the anode surface adopts a distribution pattern imitating veins of a banana leaf; a circular inner non-flow channel region 31 and a circular outer non-flow channel region 32 are respectively arranged in an inner edge and an outer edge of the rear surface of the circular plate-shaped substrate to form contact regions; a circular inner air collector flow channel 33 and a circular outer air collector flow channel 34 are respectively inscribed in an outer edge of the inner non-flow channel region and an inner edge of the outer non-flow channel region; two air inlet openings 35 and two air outlet openings 36 running through the anode surface and the cathode surface of the bipolar plate are respectively arranged in the anode surface, the air inlets and the air outlets are staggered, a primary air collector flow channel 37 is arranged along a radial direction of the air outlet openings, and the primary air collector flow channel divides, along the radial direction of the air inlet openings, a region between the inner air collector flow channel and the outer air collector flow channel into four anode sub-regions symmetrical about a center thereof; a primary flow channel 38 communicating the air inlet with the air outlet is inscribed between the air inlet opening and the air outlet opening, a central line of the primary flow channel is a circular arc, and a width of the primary flow channel progressively decreases from the air inlet to the air outlet; an inner branch flow channel 39 and an outer branch flow channel 40 are respectively arranged between the primary flow channel and the inner air collector flow channel and between the primary flow channel and the outer air collector flow channel, central lines of the inner air collector flow channels are parallel to each other, center lines of the outer air collector flow channels are parallel to each other, and an included angle of 90 degrees is defined between the inner branch flow channel and the outer branch flow channel; the width of the primary flow channel is greater than the width of the inner branch flow channel and the width of the outer branch flow channel; on the front fixing plate, a hydrogen inlet is arranged at a position corresponding to the air inlet opening in the bipolar plate, and the hydrogen inlet is communicated with the air inlet opening in the bipolar plate; and on the front fixing plate, a hydrogen outlet is arranged at a position corresponding to the air outlet opening in the bipolar plate, and the hydrogen outlet is communicated with the air outlet opening in the bipolar plate.

FIG. 7 is a sectional view of the leaf vein flow channel bionic air-cooled fuel cell module supporting lung air intake.

The impeller includes: a fixing plate, fan blades, and a fixing ring; wherein the fixing plate is a flat plate perpendicular to an axis of the sealing volute; bottoms of a plurality of evenly distributed fan blades are mounted on an edge of an inner surface of the fixing plate, and each of the fan blades is a flat plate parallel to the axis of the sealing volute; tops of the plurality of fan blades are fixed by the fixing ring; the fixing ring is mounted on the rear surface of the front fixing plate by a bearing, such that the fixing ring is rotatable with the impeller, and the front fixing plate is fixed on the sealing volute and remains stationary; and a shaft slot is arranged at a center of the fixing plate, and a drive shaft of the motor is fixedly mounted in the shaft slot of the fixing plate.

In this embodiment, cylinders in the arrays of cylinders on the cathode surface have a diameter of 3 mm, a spacing of 3 mm, and a height of 2 mm; the first-stage flow channels in the cathode surface have a width of 3 mm, a cube of the width of the first-stage flow channel is twice a cube of a width of the second-stage flow channel, a cube of the width of the second-stage flow channel is equal to a cube of a width of the third-stage flow channel; the width, in the air inlet opening, of the primary flow channel on the anode surface is 6 mm, and the width, in the air outlet opening, of the primary flow channel is 2 mm; the widths of the inner branch flow channel and the outer branch flow channel are 2 mm; and widths of the inner air collector flow channel and the outer air collector flow channel are 2.5 mm, a width of the primary air collector flow channel is 6 mm, and widths of the inner non-flow channel region and the outer non-flow channel region are 5 mm. The front fixing plate, the rear fixing plate, and the sealing volute are made of thermoplastic polyimide. The impeller is made of a thickened galvanized stainless steel plate with each part stamped and fixed by double-row pot nail mechanical riveting to ensure good physical and mechanical properties and corrosion resistance. The bipolar plate is made of graphite by press molding with a high-precision CNC machine tool to ensure smoothness of the flow channels and corrosion resistance. The anode diffusion layer and cathode diffusion layer are made of a porous carbon fiber substrate such as carbon paper or carbon cloth by cutting. The impeller is made of a thickened galvanized stainless steel plate stamping each part and then fixed by double-row pot nail mechanical riveting to ensure good physical and mechanical properties and corrosion resistance. The proton exchange membrane is made by cutting, and the surface in contact with the cathode diffusion layer and the anode diffusion layer is coated with a nano-Pt alloy to ensure the catalytic effect.

An implementation method of the leaf vein flow channel bionic air-cooled fuel cell module supporting lung air intake according to an embodiment of the present disclosure includes the following steps:
(1) air enters from the air inlet to the cathode surface inside the sealing volute of the fuel cell module while hydrogen enters the anode surface inside the sealing volute of the fuel cell module through the hydrogen inlet, and the motor drives the impeller to rotate; the air enters the fuel cell module in a way that imitates an air intake pattern of a lung, wherein the air is compressed at the air inlet to obtain a greater flow rate for flowing through the fuel cell module;
the motor drives the impeller to rotate, and the impeller provides additional power to the air, such that volume expansion of the air is accelerated and the air quickly passes through the stack;
(2) upon entry into the sealing volute, the air enters the columnar space inside the circular columnar stack and reaches the cathode surface of each of the cells in the stack, and is transported to the primary flow channel through the inner diffusion flow channel; a small amount of the air enters the mesh flow channel in a region near the primary flow channel, and is diffused within the mesh flow channel; most of the air is transported through the primary flow channel and enters narrower secondary flow channels successively up to the Mth-stage flow channel, and is diffused to the outer diffusion flow channel in the edge of the cathode flow channel network; an air flow rate is greater while being diffused to accommodate an increase in an area of the bipolar plate corresponding to the cell as an radial transportation unit length increases; and the air is evenly diffused in the cathode flow channel network while being diffused to the cathode diffusion layer of the previous cell, the region where the air is diffused to the cathode diffusion layer constitutes a reaction region, the oxygen in the air participates in reaction to generate cathode water, and the gas not participating in the reaction in the air takes away the generated cathode water and heat and is finally discharged from the air outlet;
(3) when an amount of the generated cathode water is small, the cathode water gathers at a bottom of the cathode flow channel network and forms a liquid water membrane at the bottom, the water membrane forms a liquid-gas mixed phase with the air, and the air evenly forms a flow field in the cathode flow channel network, which is conducive to the reaction while ensuring a smaller parasitic resistance;
(4) when the amount of the generated cathode water is over large, widths of the first-stage to Mth-stage flow channels of the cathode flow channel network decrease stage by stage, an additional pressure exerts a capillary effect which automatically cooperates with the air flow to discharge the gas not participating in the reaction along a radial direction, and further under power of the impeller, the cathode water is further radially transported with a transportation direction of the gas and is finally discharged from the air outlet in the side wall of the sealed volute to prevent the stack from being flooded; in terms of heat dissipation, heat is evenly generated in the whole reaction region, the heat transferred to the cathode surface is gathered on a surface of the array of cylinders, and since the arrays of cylinders are evenly arranged, the heat is evenly gathered on the surface such that a heat dissipation area is increased; further, the heat transferred to the cathode surface is transferred to gas not participating in the reaction in the air, the gas not involved in the reaction in the air includes gas not intended to participate in the reaction and the oxygen in the air failing to participate in the reaction timely, the oxygen in the air participates in the reaction during transportation and is gradually consumed, and the width of the flow channel decreases during transportation of the gas not participating in the reaction in the air along the first-stage to Mth-stage flow channels, but more heat is accumulated, the heat causes the gas not participating in the reaction in the air to expand, such that the pressure of the gas not participating in the reaction in the air increases in the limited space and is discharged from the air outlet more quickly, making the air pressure inside the sealing volute smaller and causing a pressure difference with the outside of the sealing volute, accelerating the entry of the air from the air inlet, and thus the heat provides the additional pressure for the air entering through the air inlet, which increases the air flow rate, improves an air exchange efficiency, and facilitates quickly taking away the heat by the air; and
(5) the hydrogen enters the anode surface through the air inlet opening and is transferred to the inner branch flow channel and the outer branch flow channel through the primary flow channel; since the width of the primary flow channel progressively decreases, the inner branch flow channel and the outer branch flow channel become narrower gradually, and according to the Bernoulli's law, the hydrogen is diffused quickly and evenly to each of anode sub-regions of the anode surface; most of the hydrogen is diffused to the anode diffusion layer to participate in the reaction, and a small portion of unreacted hydrogen is gathered in the inner air collector flow channel and the outer air collector flow channel and is transferred to an anode surface of a next cell through the air outlet opening; when a temperature sensor set between the stacks detects that a temperature of the cell is too high, a impeller speed is controlled to speed up to accelerate the air flow rate in the cathode flow channel network, and the entry of the hydrogen is controlled to be reduced at the same time; since an amount of entered hydrogen is reduced, and a hydrogen consumption rate in the primary flow channel and the inner and outer branch flow channels is accelerated with the air flow in the cathode flow channel network, such that the hydrogen in the main stream channel and the inner and outer branch channels is consumed quickly, and lack of the hydrogen available for the reaction slows down the reaction and slows down generation of the cathode water, but the impeller speed is accelerated, which makes the air flow rate in the cathode flow channel network accelerated to quickly take away the heat and the cathode water remaining on the cathode surface.

It should be finally noted that the embodiments herein are intended to facilitate further understanding of the present disclosure. However, a person skilled in the art would understand that various replacements and modifications can be made without departing from the spirit and scope of the appended claims of the present disclosure. Therefore, the present disclosure shall not be limited to the content disclosed by the embodiments, and the protection scope of the present disclosure shall be subject to the appended claims.

1. A leaf vein flow channel bionic air-cooled fuel cell module supporting lung air intake, comprising: an air inlet, a front fixing plate, a stack, a motor, a sealing volute, an impeller, a rear fixing plate, and an air outlet; wherein the sealing volute is a cylindrical structure having no upper bottom but having a lower bottom; the air outlet is arranged in a side wall of the sealing volute along a direction parallel to an axis of the sealing volute; the impeller is coaxially arranged inside the sealing volute, and the impeller is a cylindrical structure having no upper bottom but having a lower bottom; the rear fixing plate is coaxially arranged at a bottom inside the impeller, and the rear fixing plate is a circular flat structure; the motor is arranged at a center of the rear fixing plate; a transmission shaft of the motor is fixedly connected to a center of a bottom surface of the impeller; the stack in a circular columnar structure is coaxially mounted inside the impeller; the front fixing plate is coaxially connected at a top portion of the impeller, and a plurality of long screws are axially evenly distributed around the stack, front ends of the long screws are fixedly connected to the front fixing plate, and rear ends of the long screws are fixedly connected to the rear fixing plate, such that the stack is fixedly mounted between the front fixing plate and the rear fixing plate; a front end of the sealing volute is fixedly mounted at an edge of the front fixing plate; a through hole is arranged at a center of the front fixing plate, and the air inlet is arranged in the through hole;
wherein
an area of a cross section, along an air flow direction, of the air inlet progressively decreases along the air flow direction, such that an area at a front end of the air inlet is larger, and an area at a rear end of the air inlet is smaller;
the stack comprises a plurality of cells successively coaxially stacked, wherein each of the cells comprises from front to rear a bipolar plate, an anode diffusion layer, a proton membrane, and a cathode diffusion layer successively, and each of the cells is in a circular shape, such that the stack formed by stacking the plurality of cells is in a circular shape and a columnar space is defined inside the stack; wherein the bipolar plate employs an circular plate-shaped substrate, and a front surface, facing towards the cathode diffusion layer of a previous cell, of the bipolar plate is a cathode surface, and a rear surface, facing towards the anode diffusion layer, of the bipolar plate is an anode surface; wherein
the cathode surface adopts a mesh vein distribution pattern imitating veins of a lotus leaf; on the front surface of the circular plate-shaped substrate, arrays of cylinders are arranged like mesh veins to form mesh flow channels; a circular inner diffusion flow channel and a circular outer diffusion flow channel are respectively arranged in an inner edge and an outer edge of the front surface of the circular plate-shaped substrate; the mesh flow channels between the inner diffusion flow channel and the outer diffusion flow channel are divided by first-stage to M^{th}-stage flow channels, and the mesh flow channels and the first-stage to M^{th}-stage flow channels together form a cathode flow channel network; a plurality of first-stage flow channels distributed radially and centrosymmetrically are inscribed in an outer edge of the inner diffusion flow channel, and the first-stage flow channels are communicated with the inner diffusion flow channel; two communicated i^{th}-stage flow channels are inscribed in a tail end of each of (i−1)^{th}-stage flow channels, and the two i^{th}-stage flow channels each have an included angle with a corresponding (i−1)^{th}-stage flow channel and are symmetrically distributed about the (i−1)^{th}-stage flow channel; a tail end of the M^{th}-stage flow channel is communicated with an inner edge of the outer diffusion flow channel, wherein 2≤i≤M, M is a natural number ≥2; and a width of the (i−1)^{th}-stage flow channel is less than a width of the i^{th}-stage flow channel;
the anode surface adopts a distribution pattern imitating veins of a banana leaf; a circular inner non-flow channel region and a circular outer non-flow channel region are respectively arranged in an inner edge and an outer edge of the rear surface of the circular plate-shaped substrate to form contact regions; a circular inner air collector flow channel and a circular outer air collector flow channel are respectively inscribed in an outer edge of the inner non-flow channel region and an inner edge of the outer non-flow channel region; N air inlet openings and N air outlet openings running through the anode surface and the cathode surface of the bipolar plate are respectively arranged in the anode surface, the air inlets and the air outlets are staggered, a primary air collector flow channel is arranged along a radial direction of the air outlet openings, and the primary air collector flow channel divides, along the radial direction of the air inlet openings, a region between the inner air collector flow channel and the outer air collector flow channel into 2N anode sub-regions symmetrical about a center thereof, N being a natural number greater than or equal to 1; in each of the anode sub-regions, a primary flow channel communicating the air inlet with the air outlet is inscribed between the air inlet opening and the air outlet opening, a central line of the primary flow channel is a circular arc, and a width of the primary flow channel progressively decreases from the air inlet to the air outlet; an inner branch flow channel and an outer branch flow channel are respectively arranged between the primary flow channel and the inner air collector flow channel and between the primary flow channel and the outer air collector flow channel, a width of the inner branch flow channel progressively decreases from the primary channel to the inner air collector flow channel and a width of the outer branch flow channel progressively decreases from the primary channel to the outer air collector flow channel, central lines of the inner air collector flow channels are parallel to each other, center lines of the outer air collector flow channels are parallel to each other, and an included angle is defined between the inner branch flow channel and the outer branch flow channel; the width of the primary flow channel is greater than the width of the inner branch flow channel and the width of the outer branch flow channel; on the front fixing plate, a hydrogen inlet is arranged at a position corresponding to the air inlet opening in the bipolar plate, and the hydrogen inlet is communicated with the air inlet opening in the bipolar plate; and on the front fixing plate, a hydrogen outlet is arranged at a position corresponding to the air outlet opening in the bipolar plate, and the hydrogen outlet is communicated with the air outlet opening in the bipolar plate;
air enters from the air inlet to the cathode surface inside the sealing volute of the fuel cell module while hydrogen enters the anode surface inside the sealing volute of the fuel cell module through the hydrogen inlet, and the motor drives the impeller to rotate; the air enters the fuel cell module in a way that imitates an air intake pattern of a lung, wherein the air is compressed at the air inlet to obtain a greater flow rate for flowing through the fuel cell module; the motor drives the impeller to rotate, and the impeller provides additional power to the air, such that volume expansion of the air is accelerated and the air quickly passes through the stack;
upon entry into the sealing volute, the air enters the columnar space inside the circular columnar stack and reaches the cathode surface of each of the cells in the stack, and is transported to the primary flow channel through the inner diffusion flow channel; a small amount of the air enters the mesh flow channel in a region near the primary flow channel, and is diffused within the mesh flow channel; most of the air is transported through the primary flow channel and enters narrower secondary flow channels successively up to the M^{th}-stage flow channel, and is diffused to the outer diffusion flow channel in the edge of the cathode flow channel network; an air flow rate is greater while being diffused to accommodate an increase in an area of the bipolar plate corresponding to the cell as an radial transportation unit length increases; and the air is evenly diffused in the cathode flow channel network while being diffused to the cathode diffusion layer of the previous cell, the region where the air is diffused to the cathode diffusion layer constitutes a reaction region, oxygen in the air participates in reaction to generate cathode water, and the gas not participating in the reaction in the air takes away the generated cathode water and heat and is finally discharged from the air outlet;
when an amount of the generated cathode water is small, the cathode water gathers at a bottom of the cathode flow channel network and forms a liquid water membrane at the bottom, the water membrane forms a liquid-gas mixed phase with the air, and the air evenly forms a flow field in the cathode flow channel network, which is conducive to the reaction while ensuring a smaller parasitic resistance;
when the amount of the generated cathode water is over large, widths of the first-stage to M^{th}-stage flow channels of the cathode flow channel network decrease stage by stage, an additional pressure exerts a capillary effect which automatically cooperates with the air flow to discharge the gas not participating in the reaction along a radial direction, and further under power of the impeller, the cathode water is further radially transported with a transportation direction of the gas and is finally discharged from the air outlet in the side wall of the sealing volute to prevent the stack from being flooded; in terms of heat dissipation, heat is evenly generated in the whole reaction region, the heat transferred to the cathode surface is gathered on a surface of the array of cylinders, and since the arrays of cylinders are evenly arranged, the heat is evenly gathered on the surface such that a heat dissipation area is increased; further, the heat transferred to the cathode surface is transferred to gas not participating in the reaction in the air, the gas not involved in the reaction in the air comprises gas not intended to participate in the reaction and the oxygen in the air failing to participate in the reaction timely, the oxygen in the air participates in the reaction during transportation and is gradually consumed, and the width of the flow channel decreases during transportation of the gas not participating in the reaction in the air along the first-stage to M^{th}-stage flow channels, but more heat is accumulated, the heat causes the gas not participating in the reaction in the air to expand, such that the pressure of the gas not participating in the reaction in the air increases in the limited space and is discharged from the air outlet more quickly, making the air pressure inside the sealing volute smaller and causing a pressure difference with the outside of the sealing volute, accelerating the entry of the air from the air inlet, and thus the heat provides the additional pressure for the air entering through the air inlet, which increases the air flow rate, improves an air exchange efficiency, and facilitates quickly taking away the heat by the air; and
the hydrogen enters the anode surface through the air inlet opening and is transferred to the inner branch flow channel and the outer branch flow channel through the primary flow channel; since the width of the primary flow channel progressively decreases, the inner branch flow channel and the outer branch flow channel become narrower gradually, and according to the Bernoulli's law, the hydrogen is diffused quickly and evenly to each of anode sub-regions of the anode surface; most of the hydrogen is diffused to the anode diffusion layer to participate in the reaction, and a small portion of unreacted hydrogen is gathered in the inner air collector flow channel and the outer air collector flow channel and is transferred to an anode surface of a next cell through the air outlet opening; when a temperature sensor set between the stacks detects that a temperature of the cell is too high, a impeller speed is controlled to speed up to accelerate the air flow rate in the cathode flow channel network, and the entry of the hydrogen is controlled to be reduced at the same time; since an amount of entered hydrogen is reduced, and a hydrogen consumption rate in the primary flow channel and the inner and outer branch flow channels is accelerated with the air flow in the cathode flow channel network, such that the hydrogen in the main stream channel and the inner and outer branch channels is consumed quickly, and lack of the hydrogen available for the reaction slows down the reaction and slows down generation of the cathode water, but the impeller speed is accelerated, which makes the air flow rate in the cathode flow channel network accelerated to quickly take away the heat and the cathode water remaining on the cathode surface.

2. The leaf vein flow channel bionic air-cooled fuel cell module supporting lung air intake according to claim 1, wherein the impeller comprises: a fixing plate, fan blades, and a fixing ring; wherein the fixing plate is a flat plate perpendicular to an axis of the sealing volute; bottoms of a plurality of evenly distributed fan blades are mounted on an edge of an inner surface of the fixing plate, and each of the fan blades is a flat plate parallel to the axis of the sealing volute; tops of the plurality of fan blades are fixed by the fixing ring; the fixing ring is mounted on the rear surface of the front fixing plate by a bearing, such that the fixing ring is rotatable with the impeller, and the front fixing plate is fixed on the sealing volute and remains stationary; and a shaft slot is arranged at a center of the fixing plate, and a drive shaft of the motor is fixedly mounted in the shaft slot of the fixing plate.

3. The leaf vein flow channel bionic air-cooled fuel cell module supporting lung air intake according to claim 1, wherein the front fixing plate, the rear fixing plate, and the sealing volute are made of one of thermoplastic polyimide, polyetheretherketone, polytetrafluoroethylene, and silicone rubber.

4. The leaf vein flow channel bionic air-cooled fuel cell module supporting lung air intake according to claim 1, wherein adjacent cells in the stack are bonded by the contact regions.

5. The leaf vein flow channel bionic air-cooled fuel cell module supporting lung air intake according to claim 1, wherein the substrate of the bipolar plate is made of one of graphite, metal, and a composite material.

6. The leaf vein flow channel bionic air-cooled fuel cell module supporting lung air intake according to claim 1, wherein cylinders of the arrays of cylinder on cathode surface have a diameter of 2 to 4 mm, a spacing of 3 to 5 mm, and a height of 2 to 3 mm.

7. The leaf vein flow channel bionic air-cooled fuel cell module supporting lung air intake according to claim 1, wherein the first-stage flow channels in the cathode surface have a width of 2 to 5 mm, adjacent first-stage flow channels have an included angle of 360°/P, and a number P of first-stage flow channels satisfies 15≤P≤25.

8. The leaf vein flow channel bionic air-cooled fuel cell module supporting lung air intake according to claim 1, wherein the width, in the air inlet opening, of the primary flow channel on the anode surface ranges from 6 to 10 mm, and the width, in the air outlet opening, of the primary flow channel ranges from 1 to 4 mm; diameters of the air inlet opening and the air outlet opening range from 3 to 7 mm; the widths of the inner branch flow channel and the outer branch flow channel range from 1 to 4 mm; and widths of the inner air collector flow channel and the outer air collector flow channel range 2 to 5 mm, a width of the primary air collector flow channel range from 4 to 10 mm, and widths of the inner non-flow channel region and the outer non-flow channel region range from 2 to 10 mm.

9. An implementation method of the leaf vein flow channel bionic air-cooled fuel cell module supporting lung air intake as defined in claim 1, the implementation method comprising the following steps:
(1) air enters from the air inlet to the cathode surface inside the sealing volute of the fuel cell module while hydrogen enters the anode surface inside the sealing volute of the fuel cell module through the hydrogen inlet, and the motor drives the impeller to rotate; the air enters the fuel cell module in a way that imitates an air intake pattern of a lung, wherein the air is compressed at the air inlet to obtain a greater flow rate for flowing through the fuel cell module; the motor drives the impeller to rotate, and the impeller provides additional power to the air, such that volume expansion of the air is accelerated and the air quickly passes through the stack;
(2) upon entry into the sealing volute, the air enters the columnar space inside the circular columnar stack and reaches the cathode surface of each of the cells in the stack, and is transported to the primary flow channel through the inner diffusion flow channel; a small amount of the air enters the mesh flow channel in a region near the primary flow channel, and is diffused within the mesh flow channel; most of the air is transported through the primary flow channel and enters narrower secondary flow channels successively up to the M^{th}-stage flow channel, and is diffused to the outer diffusion flow channel in the edge of the cathode flow channel network; an air flow rate is greater while being diffused to accommodate an increase in an area of the bipolar plate corresponding to the cell as an radial transportation unit length increases; and the air is evenly diffused in the cathode flow channel network while being diffused to the cathode diffusion layer of the previous cell, the region where the air is diffused to the cathode diffusion layer constitutes a reaction region, the oxygen in the air participates in reaction to generate cathode water, and the gas not participating in the reaction in the air takes away the generated cathode water and heat and is finally discharged from the air outlet;
(3) when an amount of the generated cathode water is small, the cathode water gathers at a bottom of the cathode flow channel network and forms a liquid water membrane at the bottom, the water membrane forms a liquid-gas mixed phase with the air, and the air evenly forms a flow field in the cathode flow channel network, which is conducive to the reaction while ensuring a smaller parasitic resistance;
(4) when the amount of the generated cathode water is over large, widths of the first-stage to M^{th}-stage flow channels of the cathode flow channel network decrease stage by stage, an additional pressure exerts a capillary effect which automatically cooperates with the air flow to discharge the gas not participating in the reaction along a radial direction, and further under power of the impeller, the cathode water is further radially transported with a transportation direction of the gas and is finally discharged from the air outlet in the side wall of the sealing volute to prevent the stack from being flooded; in terms of heat dissipation, heat is evenly generated in the whole reaction region, the heat transferred to the cathode surface is gathered on a surface of the array of cylinders, and since the arrays of cylinders are evenly arranged, the heat is evenly gathered on the surface such that a heat dissipation area is increased; further, the heat transferred to the cathode surface is transferred to gas not participating in the reaction in the air, the gas not involved in the reaction in the air comprises gas not intended to participate in the reaction and the oxygen in the air failing to participate in the reaction timely, the oxygen in the air participates in the reaction during transportation and is gradually consumed, and the width of the flow channel decreases during transportation of the gas not participating in the reaction in the air along the first-stage to M^{th}-stage flow channels, but more heat is accumulated, the heat causes the gas not participating in the reaction in the air to expand, such that the pressure of the gas not participating in the reaction in the air increases in the limited space and is discharged from the air outlet more quickly, making the air pressure inside the sealing volute smaller and causing a pressure difference with the outside of the sealing volute, accelerating the entry of the air from the air inlet, and thus the heat provides the additional pressure for the air entering through the air inlet, which increases the air flow rate, improves an air exchange efficiency, and facilitates quickly taking away the heat by the air; and
(5) the hydrogen enters the anode surface through the air inlet opening and is transferred to the inner branch flow channel and the outer branch flow channel through the primary flow channel; since the width of the primary flow channel progressively decreases, the inner branch flow channel and the outer branch flow channel become narrower gradually, and according to the Bernoulli's law, the hydrogen is diffused quickly and evenly to each of anode sub-regions of the anode surface; most of the hydrogen is diffused to the anode diffusion layer to participate in the reaction, and a small portion of unreacted hydrogen is gathered in the inner air collector flow channel and the outer air collector flow channel and is transferred to an anode surface of a next cell through the air outlet opening; when a temperature sensor set between the stacks detects that a temperature of the cell is too high, a impeller speed is controlled to speed up to accelerate the air flow rate in the cathode flow channel network, and the entry of the hydrogen is controlled to be reduced at the same time; since an amount of entered hydrogen is reduced, and a hydrogen consumption rate in the primary flow channel and the inner and outer branch flow channels is accelerated with the air flow in the cathode flow channel network, such that the hydrogen in the main stream channel and the inner and outer branch channels is consumed quickly, and lack of the hydrogen available for the reaction slows down the reaction and slows down generation of the cathode water, but the impeller speed is accelerated, which makes the air flow rate in the cathode flow channel network accelerated to quickly take away the heat and the cathode water remaining on the cathode surface.
